(19) United States
(12) Patent Application Publication
(10) Pub. No.: US 2011/0089701 A1
(43) Pub. Date: Apr. 21, 2011

(54) Methods and apparatus for generating electrical energy based on waste air flow

(76) Inventor: Vincent M. Blake, Hoffman Estates, IL (US)

(21) Appl. No.: 12/925,028

(22) Filed: Oct. 12, 2010

Related U.S. Application Data
(60) Provisional application No. 61/279,095, filed on Oct. 16, 2009.

(51) Int. Cl. F03D 9/00

(52) U.S. Cl. 290/55

(57) ABSTRACT

Methods and apparatus are provided for generating electrical power employing a horizontal axis wind turbine operatively coupled to a permanent magnet generator/alternator and mounted vertically above a waste air flow source so that vertically ascending waste air from the waste air flow source impacts the turbine and causes the permanent magnet generator/alternator to generate electrical power.

This application claims the benefit of U.S. Provisional application Ser. No. 61/279,095, filed Oct. 16, 2009.

### BACKGROUND OF THE INVENTION

1. Field of the Invention

This invention relates to a horizontally mounted wind turbine positioned vertically above an exhaust air flow source in a manner such that the exhaust air flow causes the turbine to rotate and cause a permanent magnet electrical generator/alternator coupled to the turbine to generate electrical energy. More particularly, the horizontal axis wind turbines are positioned to generate electrical energy in an efficient and cost effective manner based on vertically ascending waste air flow, preferably fan driven, exiting from a waste air source such as a commercial cooling tower, a roof top air conditioning unit, an exhaust fan and the like.

2. Description of Related Art

Solving the problem of global warming is a worldwide issue rather recently brought into popular focus, particularly, in view of the downturn in the global economy and rising fuel and utility prices. However, the scientific community has been aware of this issue for decades. Greenhouse gas emissions, created by the production of electricity through use of fossil fuels, have been known to be a major contributor to the global warming problem. Furthermore, it has been recognized that use of renewable energy sources, such as wind and solar, are greenhouse gas emission free sources of electricity. The main problem with these renewable energy sources is that they are unpredictable or impractical for use in providing energy for individual urban buildings. Significantly, current methods relying on nature for wind and solar electrical energy production do not guarantee electrical production during peak electrical use periods nor can the duration of meaningful electrical production be accurately predicted due to these same problems.

Natural wind has been an important source of energy in the U.S. for a long time. The mechanical windmill was one of the “high-technology” inventions of the late 1800's that enabled much of the development of the western frontier of the U.S. Over 8 million mechanical windmills have been installed in the U.S. since the 1860's and some of these units have been in operation for more than a hundred years. In the 1920's and 1930's, before the REA began subsidizing rural electric co-ops and electric lines, farm families throughout the Midwest used 200-3,000 watt wind generator/alternators/alternators to power lights, radios, and kitchen appliances. However, the modest wind industry that had built up by the 1930's was literally driven out of business by government policies favoring the construction of utility lines and fossil fuel power plants. In the late 1970's and early 1980's intense interest was once again focused on natural wind energy as a possible solution to the energy crisis. As people looked to various electricity producing renewable energy alternatives, small wind turbines emerged as a cost effective technology capable of reducing utility bills.

Tax credits and favorable federal regulations (PURPA) made it possible for over 4,500 small (e.g., 1-25 kW) utility-interconnected wind systems to be installed between 1976 and 1985. Another 1,000 systems were installed in various remote applications during the same period. Today, small wind turbines are installed in all 50 United States.

As a power source, natural wind energy is less predictable than solar energy, but it is also typically available for more hours in a given day. Natural wind resources are best along coastlines, on hills, and in the northern climate states, but usable natural wind resources can be found in most areas. Natural wind resources being susceptible to the influences of terrain and other factors, make it much more site specific than solar energy. In hilly terrain, for example, adjoining properties are likely to have the exact same solar resource, but one property could have a much better wind resource than the adjoining property because the neighboring property may be on top of a hill or have a better exposure to a prevailing natural wind direction. Conversely, if one property is in a gully or on the leeward side of a hill, the natural wind resource exposure could be substantially lower. In this regard, natural wind energy resources must be considered somewhat more carefully than solar energy. Natural wind energy resources follow seasonal patterns that provide the best performance in the winter months and the lowest performance in the summer months. This is just the opposite of solar energy.

Most natural wind turbines in use today are either the horizontal-axis propeller type or the vertical-axis type, such as the egg-beater like Darrieus style or the S-rotor type Savonius style. A horizontal-axis wind turbine consists of a rotor, a generator, a mainframe, and, usually, a tail, placed on a tall tower. The rotor captures the kinetic energy of the wind and converts it into rotary motion to drive the generator/alternator. The rotor may be a single or multiple blade assembly but usually the rotor consists of two or three blades. In use, a three blade unit may be somewhat more efficient and may run smoother than a two blade rotor. The rotor blades may be constructed from any suitable material but are usually made from either wood or fiberglass because these materials have the desired combination of strength and flexibility and, also, do not cause interference with ambient electronic signals such as television signals.

### SUMMARY OF THE INVENTION

The present invention relates to horizontal axis wind turbines and methods for cost effectively and efficiently utilizing such turbines in power system grids to generate electric power employing currently available and unutilized waste air flow sources to drive such turbines.

In accordance with the present invention, a novel approach is provided to generate electrical power for commercial use by employing wind power turbines driven by exhaust air streams from mechanical equipment such as the mechanical equipment used to control the indoor climate of urban buildings. The use of such mechanical equipment is a long standing industrial practice in commercial buildings. But the exhaust air flow derived from such mechanical equipments has been treated merely as undesirable waste and has not been utilized effectively heretofore.

The present invention provides methods and apparatus for utilizing such exhaust waste air flow streams from sources such as commercial cooling towers, roof top air conditioning units, exhaust fans and the like to power permanent magnet generator/alternators coupled to horizontal axis turbines including rotatably mounted impellers such as multiple bladed air-driven impellers, particularly, three or four bladed airfoil impellers; helical coil impellers and the like.

The horizontal axis turbines employed in the methods of the present invention are mounted vertically over an exhaust air stream source so that vertically ascending waste air flow from the waste air stream source will impact the rotatably mounted impellers causing such rotatable elements to rotate and cause associated permanent magnet generator/alternators operatively coupled to the turbines to generate useable electrical power.

The permanent magnet generator/alternators employed in this invention are powered based on the rotary motion of airfoils or helical coils or similar such impeller elements to provide useable electricity. The apparatus of this invention may be unitized into discrete sections, preferably, sized to generate about 500 watts to about 7,500 watts or more. Preferably, the discrete sections of the apparatus of this invention have dimensions of about 2.5 feet to about 4 feet in width and about 8 feet to about 18 feet in length with a permanent magnet generator/alternator operably mounted to each such unitized section.

The unitized constructions of the present invention normally are structured so as to cover approximately 20%-40% of the open surface of an exhaust fan which supplies the waste air stream which causes rotation of the rotatable elements of the apparatus of the present invention. Thus, approximately 60%-80% of the open surface of the fan is left unimpeded. Furthermore, in a preferred embodiment of the present invention, when the rotatable elements of the apparatus of this invention reach a desired rotary speed of about 150-500 revolutions per minute (RPM) any impedance to the air flow should be effectively eliminated.

It should be noted that the useable electricity derived from a system employing the apparatus of this invention may be connected to a power distribution system in a building such as a commercial, professional or residential structure or the like by means of an inverter or rectifier and a series of National Electric Code required safety power disconnect switches. Thus, use of the apparatus of the present invention to generate electrical power will greatly improve the efficiency of associated power providing equipment (commercial cooling tower, roof top air conditioning unit or exhaust fan) by reducing the electrical power provided by the utility and consumed by the building lowering carbon dioxide (CO²) emissions.

### BRIEF DESCRIPTION OF THE DRAWING

The present invention will become more fully understood from the detailed description given herein below and the accompanying drawings which are given by way of illustration only, and thus are not intended as a definition of the limits of the present invention, and wherein:

FIG. 1 is an end view illustrating one embodiment of the present invention wherein a horizontal axis wind turbine having rotatable air/wind impellers is operatively coupled to a permanent magnet generator/alternator via a shaft bearing and the permanent magnet generator/alternator is mounted in a support framework positioned atop a structure such as a cooling tower having blower fans for exhausting air vertically from the tower in a manner such that vertically ascending waste air flow from the cooling tower will impact the turbine impellers and will cause the impellers to rotate and drive the permanent magnet generator/alternator whereby electrical power is generated;

FIG. 2, is a top view illustrating the embodiment of this invention depicted in FIG. 1 wherein the horizontal axis wind turbine is operatively coupled to the permanent magnet generator/alternator and is mounted vertically above the mechanical structure including a cooling tower so that the vertically ascending waste air stream from the cooling tower will impact the turbine impellers and cause them to rotate and drive the permanent magnet generator/alternator to generate electrical power;

FIG. 3 is a side view further illustrating the embodiment of this invention depicted in FIGS. 1 and 2 wherein the horizontal axis wind turbine is operatively coupled to a permanent magnet generator/alternator and the permanent magnet generator/alternator is mounted vertically above the cooling tower in a support framework whereby the wind turbine is positioned above a cooling tower so that waste air exiting from the cooling tower with the aid of blower fans positioned therein for exhausting the waste air vertically from the cooling tower will impact the impellers of the turbine causing the impellers to rotate and drive the permanent magnet generator/alternator to generate electrical power;

FIG. 4 is an end view illustrating a preferred embodiment of a horizontal axis wind turbine of the present invention wherein an alternately configured impeller arrangement is horizontally mounted on the horizontal axis wind turbine via armatures connected to a hub having a central shaft operatively coupled to a permanent magnet generator/alternator. As illustrated, the turbine of this invention has three airfoil style impeller blades thereon which are joined to separate armatures connected to the central shaft via the hub. Thus, the turbine which is operatively coupled to the permanent magnet generator/alternator via a shaft bearing and is mounted in a support framework to position the turbine, for example, above a vertically ascending waste air stream from a mechanical structure such as a cooling tower so that vertically ascending waste air stream from the cooling tower will impact the airfoil style impeller blades and cause the impeller arrangement to rotate and drive the permanent magnet generator/alternator whereby electrical energy is generated;

FIG. 5 is a side view illustrating the embodiment of the horizontal axis wind turbine shown in FIG. 4 employing the impeller design depicted therein with the turbine operatively coupled to a permanent magnet generator/alternator via a shaft bearing and mounted in a support framework for mounting in a desired position such as vertically above a desired waste air stream source so that a vertically ascending waste air stream will impact the turbine with the airfoil style impeller and the blades thereon to cause the impeller to rotate and drive the permanent magnet generator/alternator to generate electrical power;

FIG. 6 is a top view illustrating the horizontal axis wind turbine shown in FIGS. 4 and 5 operatively coupled to a permanent magnet generator/alternator via a shaft bearing and mounted in a support framework for mounting in a desired position vertically above a waste air stream source so that a vertically ascending waste air stream will impact the multi-bladed airfoil style impeller to cause the impeller to rotate and drive the permanent magnet generator/alternator whereby electrical power is generated;

FIG. 7 is a perspective view showing in greater detail a multi-bladed airfoil style impeller for positioning on a horizontal axis wind turbine as illustrated in FIGS. 4-6 with the impeller having three blades thereon configured to facilitate and promote rotary motion of the impeller when vertically ascending air streams impact the impeller with the blades thereon.

FIG. 8 is an end view illustrating another embodiment of the horizontal axis wind turbines of the present invention wherein an alternative helical impeller shaped design is employed on the turbine which is operatively coupled to the permanent magnet generator via a shaft bearing and mounted in a support framework positioning the turbine above a waste air stream source such as a cooling tower so that vertically ascending waste air stream from the cooling tower will impact the turbine impellers and causes them to rotate and drive the permanent magnet generator to generate electrical power;

FIG. 9 is a top view illustrating the embodiment of the horizontal axis wind turbine shown in FIG. 8 employing the helical coil shaped impeller depicted therein with the turbine operatively coupled to a permanent magnet generator/alternator via a shaft and shaft bearing and mounted in a support framework to position the turbine having the helical shaped impellers vertically above a desired air stream source so that a vertically ascending air stream from a fan will impact the helical coil shaped turbine impellers and cause them to rotate and drive the permanent magnet generator/alternator to generate electrical power; and

FIG. 10 is a side view illustrating the embodiment of the horizontal axis wind turbine shown in FIGS. 8 and 9 employing the helical coil shaped impellers depicted therein with the turbine operatively coupled to a permanent magnet generator/alternator via a shaft and shaft bearing and mounted in a support framework to position the turbine vertically above a desired air stream source so that a vertically ascending air stream from mechanical equipment such as the illustrated fan will impact the helical turbine impellers and cause them to rotate and drive the permanent magnet generator/alternator to generate electrical power.

### DETAILED DESCRIPTION OF PREFERRED EMBODIMENTS

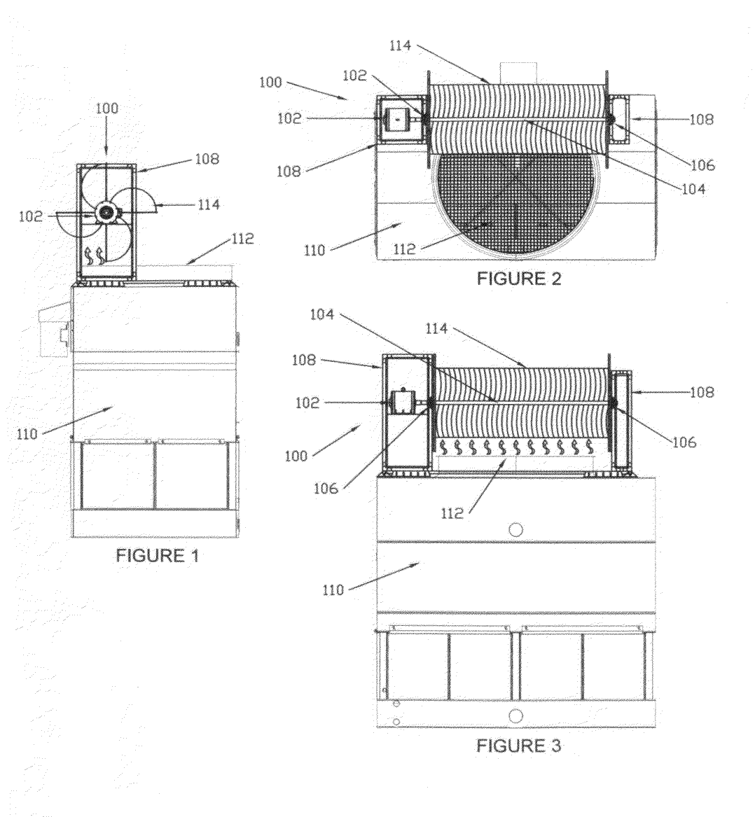

Preferred embodiments of the present invention will be described in detail hereinbelow along with drawings illustrating the invention. In the present embodiments, a downwind horizontal axis wind turbine 100 shown in FIGS. 1 to 10 is adopted as an example of a horizontal axis wind turbine.

Specifically, as shown in FIGS. 1 to 3, a horizontal axis wind turbine 100 is operatively coupled to a permanent magnet generator/alternator 102 (‘P.M.G.”) via a shaft 104 and shaft bearings 106 and the P.M.G. 102 is mounted in a support framework 108 positioned vertically above a vertically ascending air flow source such as a waste air stream from a cooling tower 110. The cooling tower 110 has blower fans 112 positioned therein for assisting waste air from the tower 110 to be expelled vertically from the tower 110. The horizontal axis wind turbine 100 includes rotatable impellers 114 which are positioned to be impacted by a vertically ascending waste air stream (illustrated by arrows 112) exiting from the cooling tower 110 causing the impellers 114 to rotate and drive the P.M.G. 102, preferably at a rate of between about 150-500 revolutions per minute (RPMs), most preferably, at about 150-250 RPMs whereby electrical power is generated.

The present invention operates at a preferred design speed of 150-500 RPM allowing for a predictable electrical production output based on the constant air velocities produced by mechanical equipment. As most mechanical equipment operates at times of peak electrical use, the electricity produced will decrease the utility power required during the hours of operation of the mechanical equipment. In construction, the air impellers of the present invention are positioned within a framework at a distance of approximately one to four feet above the air source and are independently supported from the framework supporting the mechanical equipment providing the air source.

The useable electricity generated by the systems of this invention can be connected to a building power distribution system by means of an inverter or rectifier and a series of National Electric Code required safety power disconnect switches. The current invention will greatly improve the efficiency of the associated mechanical equipment by reducing the electrical power provided by the utility and consumed by the building lowering greenhouse gas emissions.

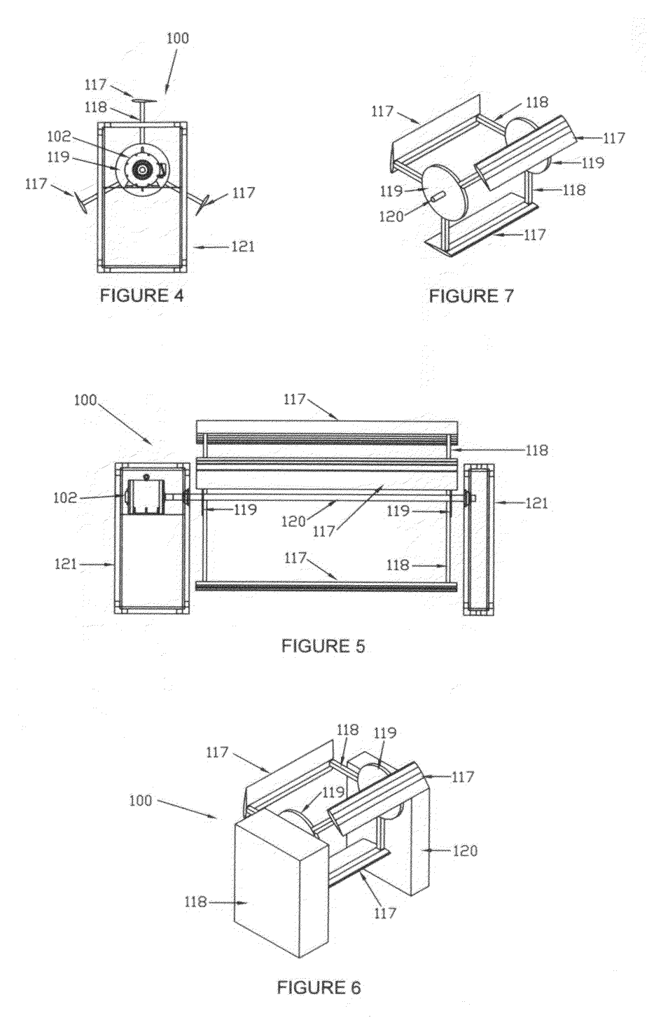

In a preferred embodiment of this invention as illustrated, for example, in FIGS. 4-7 herein, a horizontally mounted wind turbine 100 having three airfoil style impeller arrangements 116 thereon including three airfoil style blades 117 and three armatures 118 connecting the blades 117 to hub 119 having a shaft 120 operatively engaged with permanent magnet generator/alternator 102. As illustrated in FIGS. 4-7, the impeller arrangement 116 has three blades 117 thereon although four bladed or other multiple blade options may be employed, if desired. As further illustrated, the turbine 100 is supported by two mounting pedestals 121, which are connected to and directly supported by associated mechanical equipment (not shown) such as the top of a cooling tower and the like. This mounting arrangement may weigh up to approximately 850 pounds (lbs.) or about 385 kilograms (kg.) (+/−).

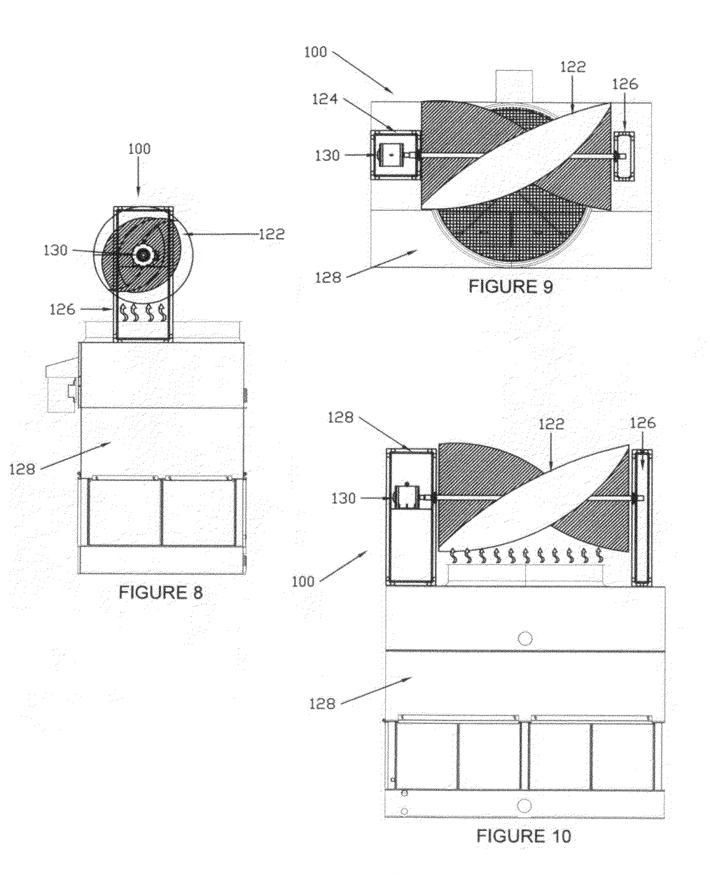

In a further preferred embodiment of this invention as illustrated, for example, in FIGS. 8-10, a horizontally mounted wind turbine 100 having a helical shaped impeller 122 thereon is supported by two mounting pedestals 124 and 126, which are connected to and directly supported by associated mechanical equipment 128 such as the top of a cooling tower and the like and the rotation of the turbine will cause the P.M.G. 130 to generate electrical power as described above.

In accordance with this invention, electrical energy may be generated from various independent sources but, preferably, will result from the use of waste exhaust air flow from sources such as mechanical heating, cooling and ventilating (HVAC) equipment. However, a secondary source for generating electrical energy is natural wind. Thus, the turbine impellers employed in this invention should be specifically sized and designed to operate optimally, when they are placed horizontally in the waste air flow stream above HVAC equipment at a height, which is determined by the mechanical waste air flow speed. The impeller should be designed to achieve about 150-500 RPMs in a mechanical waste air stream having a speed of between about 19-38 miles per hour (MPH) (or about 30-61 kilometers per hour (Km/H). This requires a mounting height (at the leading edge of the impeller blade closest to the mechanical waste air source) of between about 1 foot or about 30.5 centimeters (cm) and about 4 feet or about 122 cm. The impellers of this invention should be further designed to produce electrical energy in natural environments wherein the wind speed is between about 11-38 MPH or about 18-61 Km/H.

The construction of the various impellers employed in this invention including, for example, the rotatable impellers 114 shown in FIGS. 1-3 herein, the multi-bladed airfoil style impellers 116 shown in FIGS. 4-7 and the helical impeller blades 122 shown in FIGS. 8-10 are designed to maximize the efficiency of the turbines of this invention with a “swept face area” (i.e., the face area available to the wind), preferably, between about 7.85 square feet (about 0.73 square meters) and about 452.16 square feet (about 42 square meters) (i.e., about one-half of the circumference area of a preferred wheel). It should be noted that excess wind speed above the maximum design specification of about 38 MPH (or about 61 Km/H) can be accommodated by a resistive load electric braking system associated with an inverter/converter to slow the impeller.

The electrical energy production of this invention will be both predictable and consistent as its principal mode of operation will be when the associated HVAC equipment is in operation. To better understand the uniqueness of this invention, it should be understand that most, if not all natural wind source electrical energy turbines in use today are either the horizontal-axis, propeller type or the vertical-axis, egg-beater type, like the Darrieus style or the S-rotor type Savonius style. These natural wind electrical energy turbines depend on the horizontal flow of natural wind. This natural horizontal flow of wind is a form of solar energy produced by uneven heating of the Earth's surface, causing air to move at an increased velocity parallel to the Earth's surface.

Natural wind electrical energy turbines are oriented to be at right angles to their natural wind source. Furthermore, their blades or rotors are sized to take the best advantage of the normally low velocities of natural wind. Perhaps the most important formula in regard to wind power is the following standard power formula which calculates how much energy is available in the wind (not how much energy can be extracted):

Power in the Wind (Watts)=½rho(A)(V³)

wherein
Rho=1.23 (which is the air density of 1 cubic meter of air weighing 1.23 kg at sea level);
A=the swept area of the rotor blades in square meters (e.g., if the wind turbine has a rotor blade diameter of 3 meters (or about 10 feet) then the swept area will be just over about 7 square meters or about 80 square feet).
V=velocity (wind speed, in meters per second).

In regard to the above formula, it should be noted that doubling the rotor blade diameter will cause the machine to sweep 4 times the area. That is, the power available from a natural wind energy turbine is related to the square of the blade diameter. Also, it should be noted that in the formula the velocity (V) is to the 3rd power (cubed) which means that doubling wind speed will provide 8 times the available energy. This fact is very significant in designing a turbine for use in a system since if a machine is designed to produce usable power in a 10 MPH (or about 16 Km/H) wind, then it has to deal with 8 times more energy in a 20 MPH (or about 32 Km/H) wind and 64 times that much energy in a 40 MPH (or about 64 Km/H) wind and 512 times that much energy in a 80 MPH (or about 128 Km/H) wind, etc.

Thus, it should be recognized that in accordance with this invention, electrical energy may be generated based on the interaction of natural wind on the impellers such as the airfoils of the turbines based on the above discussed standard power formula. However, notably the apparatus and methods of the present invention enable electrical energy to be generated primarily based on air flow resulting from the use of exhaust air flows which have previously been acknowledged to be waste exhaust air flow with no beneficial purposes from sources such as mechanical heating, cooling and ventilating (HVAC) equipment.

To the contrary, the turbines employed in this invention are specifically sized and designed to operate optimally when they are placed horizontally in the air stream above the ascending air flow from such sources as HVAC equipment and are positioned in the waste air flow stream at an optimal height as determined by the mechanical waste air flow speed. For example, the impellers such as the airfoils employed herein are designed to achieve about 150-500 RPM's based on a mechanical waste air stream velocity of between about 19-38 MPH (or about 30-61 Km/H) which normally requires a mounting height (at the leading edge of the impeller blade closest to the waste air source) of between about 1 foot and about 4 feet. Furthermore, as noted above, the airfoils or impellers employed herein have been designed to produce electrical energy in natural wind speeds of between about 11-38 MPH (or about 18-61 Km/H).

Accordingly, it is a primary object of this invention to provide apparatus, systems and methods for predictable and consistent production of cost effective, efficient and environmentally friendly, electrical energy utilizing previously acknowledged waste exhaust air stream flows.

Although the present invention has been described in its preferred forms with a certain degree of particularity, it is to be understood that the disclosure herein has been made by way of example only. Numerous changes in the details of the construction and operation thereof well as the methods of use will be apparent without departing from the spirit and scope of the invention, as defined in the appended claims.

1. An apparatus for generating electrical power utilizing a waste air source comprising:
(a) a horizontal axis wind turbine having at least one rotatable impeller mounted in a plane oriented longitudinally of the horizontal axis of the wind turbine and substantially parallel to the horizontal axis of the wind turbine for rotation radially about the horizontal axis of the wind turbine and;
(b) a permanent magnet generator/alternator operatively coupled to the wind turbine;
(c) a waste air flow source providing a substantially unidirectional waste air flow path;
(d) the at least one rotatable impeller on the wind turbine being mounted directly in the waste air flow path whereby the waste air flow from the waste air flow source impacts the at least one impeller on the wind turbine and causes the at least one impeller to rotate radially about the horizontal axis of the wind turbine causing the permanent magnet generator/alternator to generate electrical power.

2. The apparatus of claim 1 wherein the waste air flow source is a mechanical exhaust system selected from the group consisting of commercial cooling towers, roof top air conditioning units and exhaust fans.

3. The apparatus of claim 2 wherein the substantially unidirectional waste air flow path from the waste air flow source flows at a constant velocity from the mechanical exhaust system.

4. The apparatus of claim 1 wherein the at least one impeller comprises multiple airfoil shaped blades structured to extend longitudinally along the horizontal axis of the wind turbine.

5. The apparatus of claim 4 wherein each of the airfoil shaped blades is connected to the horizontal axis at two or more points along the length of the axis.

6. The apparatus of claim 1 wherein the at least one impeller is a helical coil shaped blade structured with a twist of at least 180° along the length of the horizontal axis of the wind turbine.

7. The apparatus of claim 1 wherein the at least one impeller achieves about 150-500 RPM in a waste air flow having a velocity of between about 19-38 MPH (about 30-61 Km/H).

8. The apparatus of claim 7 wherein the at least one impeller is mounted at a height closest to the waste air flow source of between about 1 foot and about four feet (about 30.5 cm and about 122 cm).

9. The apparatus of claim 1 wherein the at least one impeller causes the permanent magnet generator/alternator to produce electrical energy in natural wind at speeds of between about 11 and about 38 MPH (about 18 and about 61 Km/H).

10. A method for generating electrical power utilizing a waste air source comprising:
(a) mounting a horizontal axis wind turbine having at least one rotatable impeller thereon in a substantially unidirectional waste air flow path from a waste air flow source, the at least one rotatable impeller on the horizontal axis wind turbine being aligned in a plane oriented longitudinally of the horizontal axis of the wind turbine and substantially parallel to the horizontal axis of the wind turbine for rotation radially about the horizontal axis of the wind turbine;
(b) operatively coupling a permanent magnet electric generator/alternator to the horizontal axis wind turbine;
(c) positioning the horizontal axis wind turbine in a manner such that the waste air from the waste air flow source impacts the at least one rotatable impeller on the wind turbine causing the at least one impeller to rotate radially and activate the permanent magnet electric generator/alternator and cause the permanent magnet generator/alternator to generate electrical power.

11. The method of claim 10 wherein the waste air flow source is a constant velocity mechanical exhaust device.

12. The method of claim 10 wherein the waste air flow source is a mechanical exhaust system selected from the group consisting of commercial cooling towers, roof top air conditioning units and exhaust fans.

13. The method of claim 10 wherein the at least one impeller comprises multiple airfoil shaped blades structured to extend longitudinally along the horizontal axis of the wind turbine.

14. The method of claim 13 wherein each of the airfoil shaped blades is connected to the horizontal axis at two or more points along the axis.

15. The method of claim 10 wherein the at least one impeller is a helical coil shaped blade structured with a twist of at least 180° along the length of the horizontal axis of the wind turbine.

16. The method of claim 10 wherein the waste air flow source causes the at least one rotatable impeller on the horizontal axis wind turbine to rotate at between about 150-250 RPM.

17. The method of claim 10 wherein the at least one rotatable impeller achieves about 150-500 RPM in a waste air flow having a velocity of between about 19-38 MPH (about 30-61 Km/H).

18. The method of claim 17 wherein the at least one rotatable impeller is mounted at a height closest to the waste air flow source of between about 1 foot and about 4 feet (about 30.5 cm and about 122 cm).

19. The method of claim 10 wherein the at least one impeller causes the permanent magnet generator/alternator to produce electrical energy in natural wind speeds of between about 11 and about 38 MPH (about 18 and about 61 Km/H).
